(19) United States
(12) Patent Application Publication
(10) Pub. No.: US 2010/0236533 A1
(43) Pub. Date: Sep. 23, 2010

(54) Valve Seat Insert for a Split-Cycle Engine

(76) Inventors: Riccardo Meldolesi, Hove (GB); Anthony Stuart Perkins, Shoreham-By-Sea (GB); Clive Barrington Lacy, (US); Barry Edward Westmoreland, Adkins, TX (US); Marc Christopher Megel, La Vernsa, TX (US)

Correspondence Address: Scuderi Group LLC, 1111 Elm Street, Suite 33, West Springfield, MA, 01089, US

(21) Appl. No.: 12/408,814

(22) Filed: Mar. 23, 2009

(51) Int. Cl. F02B 33/22; F16K 1/42

(52) U.S. Cl. 123/70 R; 251/359; 123/188.8

(57) ABSTRACT

The present invention provides an improved valve seat insert, particularly for split-cycle engines with outwardly opening crossover valves. The improved valve seat insert combines an interference fit section with a threaded section. The interference fit section aligns a valve seat and can prevent rotation of the valve seat insert. The threaded section prevents axial movement of the valve seat insert.

### TECHNICAL FIELD

The present invention generally relates to a valve seat insert for use with outwardly opening valves. More specifically, the present invention relates to a valve seat insert in a split-cycle internal combustion engine for one or more valves that open away from the interior of the cylinders and a method of installing such a valve seat insert.

### BACKGROUND OF THE INVENTION

For purposes of clarity, the term “conventional engine” as used in the present application refers to an internal combustion engine wherein all four strokes of the well known Otto or Diesel cycle (the intake, compression, expansion and exhaust strokes) are contained in each piston/cylinder combination of the engine. Each stroke requires one half revolution of the crankshaft (180 degrees crank angle (CA)), and two full revolutions of the crankshaft (720 degrees CA) are required to complete the entire Otto or Diesel cycle in each cylinder of a conventional engine.

In a conventional internal combustion engine valves generally control flow of the working fluids into and out of the engine's cylinders. The valves are normally inwardly opening. That is, the valves normally open towards the inside of the cylinders. In such engines, valve seat inserts that provide valve seats for the valves are often installed into the cylinder head. Valves then close by abutting a valve seat of a valve seat insert.

Prior art valve seat inserts are typically installed into a recess in the side of the cylinder head that faces the cylinder during operation of the engine. Prior art valve seat inserts are generally held in place within the recess by a radial interference (or press) fit. An interference (or press) fit is a fastening between two parts achieved by friction, as is well known in the art. To achieve a radial interference fit, prior art valve seat inserts have typically been manufactured such that the diameter of the outer periphery of the valve seat insert is at least slightly larger than the diameter of the inner periphery of the recess in the cylinder head when the valve seat insert and the recess in the cylinder head are approximately at the same temperature. Typical installation techniques for installing valve seat inserts into the recess of a cylinder head include using a large amount of force, heating the recess of the cylinder head so that it expands radially, and/or cooling the valve seat insert so that it contracts radially.

During operation of an internal combustion engine with inwardly opening valves and a prior art valve seat insert as described above, when the inwardly opening valves move into their closed position they impact the side of the valve seat insert that faces the interior of the cylinder. This impact tends to push the valve seat insert towards the cylinder head and into the recess in the cylinder head, which helps keep the valve seat insert in the recess of the cylinder head.

Problematically, outwardly opening valves create the opposite effect. When outwardly opening valves close they impact the side of a prior art valve seat insert that faces away from the interior of the cylinder. This impact tends to push the valve seat insert towards the interior of the cylinder head and out of the recess in the cylinder head, which could potentially dislodge the valve seat insert from the recess of the cylinder head.

The impact problem is exacerbated in internal combustion engines with fast valve actuation rates where the valve velocity is greater than 6 meters/second. This is because the impacts against the valve seat insert can occur very frequently, with relatively high valve seating velocities and/or with greater force.

The impact problem is also exacerbated in internal combustion engines with high pressure fluid in contact with an outwardly opening valve or valve seat insert. The high pressure fluid can put pressure on the valve seat insert and/or increase the force with which the valve impacts the valve seat. Both of these factors tend to push the valve seat insert towards the interior of the cylinder and out of the recess.

The impact problem is further exacerbated in applications that require valve seat inserts with a short axial height. The shorter the axial height, the less room there is for the interference fit section. In other words, the retention force of an interference fit is a product, amongst other factors, of (1) the radial pressure between the interfering components, (2) the area of the interference surfaces, and (3) the coefficient of friction between the interference surfaces. Accordingly, reducing axial height of the valve seat insert in a cylinder head reduces total surface area, thereby reducing retention force. Therefore, in order to retain a required minimum retention force to keep the valve seat insert in place, the reduced height would have to be compensated by an increase in the radial interference between the valve seat insert and the recess of the cylinder head. Problematically, a large radial interference would likely lead to component failure. Accordingly, the prior art methodology of designing a radial interference fit between valve seat and cylinder head is not feasible on its own.

An alternative design could use a screwed in valve seat. The use of a threaded joint is capable of generating high axial (length wise) forces without the drawbacks of the high material stresses of the radial interference fit. However, the risk of disassembly is real even for the threaded joint, because the impacts at valve closing would generate vibrations potentially capable, in time, of unscrewing the seat. In normal bolted joints, this problem is normally solved by creating an axial preload, which in turn generates friction forces that prevent the movable threaded component from unscrewing. This practice normally requires fairly axially compliant elements (e.g., bolts) whose lengths are multiples of the thread diameters (e.g., greater than 1). This allows the storing of elastic energy through a non-negligible axial deformation so that any relaxation in the joint after tightening and during operation will have only a marginal effect on the loss of tightening load.

Problematically however, in engine valve seat applications, it is not possible to have long components. This is because lengthy valve seats would interfere with the packaging of other features and components in the cylinder head assembly.

In addition, use of outwardly opening valves raises assembly problems when used with conventional valve seat inserts. This is due to the fact that a conventional valve seat insert installed in the recess of a cylinder head prevents outwardly opening valves from being extracted because the throat of the valve seat insert is smaller than the outer diameter of the valve head.

The split-cycle engine is an example of an engine that suffers the aforementioned problems and disadvantages when used with conventional valve seat inserts. For purposes of clarity, the following definition is offered for the term “split-cycle engine” as may be applied to engines disclosed in the prior art and as referred to in the present application.

A split-cycle engine, as referred to herein, comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft; and

a crossover passage interconnecting the compression and expansion cylinders, the crossover passage including a crossover compression (XovrC) valve and a crossover expansion (XovrE) valve defining a pressure chamber therebetween.

Referring to FIG. 1, an exemplary embodiment of a prior art split-cycle engine is shown generally by numeral 10. The split-cycle engine 10 replaces two adjacent cylinders of a conventional engine with a combination of one compression cylinder 12 and one expansion cylinder 14. The four strokes of the Otto cycle are “split” over the two cylinders 12 and 14 such that the compression cylinder 12 contains the intake and compression strokes and the expansion cylinder 14 contains the expansion and exhaust strokes. The Otto cycle is therefore completed in these two cylinders 12, 14 once per crankshaft 16 revolution (360 degrees CA).

During the intake stroke, intake air is drawn into the compression cylinder 12 through an inwardly opening (opening inward into the cylinder) poppet intake valve 18. During the compression stroke, the compression piston 20 pressurizes the air charge and drives the air charge through the crossover passage 22, which acts as the intake passage for the expansion cylinder 14.

An outwardly opening (opening outward away from the cylinder) poppet crossover compression (XovrC) valve 24 at the crossover passage inlet is used to control flow from the compression cylinder 12 into the crossover passage 22. An outwardly opening poppet crossover expansion (XovrE) valve 26 at the outlet of the crossover passage 22 controls flow from the crossover passage 22 into the expansion cylinder 14. Significantly, the actuation rates and phasing of the XovrC and XovrE valves 24, 26 are timed to maintain pressure in the crossover passage 22 at a high minimum pressure (typically 20 bar or higher) during all four strokes of the Otto cycle.

A fuel injector 28 injects fuel into the pressurized air at the exit end of the crossover passage 22 in correspondence with the XovrE valve 26 opening. The fuel-air charge fully enters the expansion cylinder 14 shortly after expansion piston 30 reaches its top dead center position. As piston 30 begins its descent from its top dead center position, and while the XovrE valve 26 is still open, spark plug 32 is fired to initiate combustion (typically between 10 to 20 degrees CA after top dead center of the expansion piston 30). The XovrE valve 26 is then closed before the resulting combustion event can enter the crossover passage 22. The combustion event drives the expansion piston 30 downward in a power stroke. Exhaust gases are pumped out of the expansion cylinder 14 through inwardly opening poppet exhaust valve 34 during the exhaust stroke.

Dynamic actuation of the crossover valves 24, 26 is very demanding. This is because the crossover valves 24, 26 must achieve sufficient lift to fully transfer the fuel-air charge in a very short period of crankshaft rotation (generally in a range of about 30 to 60 degrees CA) relative to that of a conventional engine, which normally actuates the valves within 180 to 220 degrees CA. This means that the crossover valves 24, 26 must actuate about four to six times faster than the valves of a conventional engine.

As discussed above, fast actuation rates, outwardly opening valves, pressure on a valve seat insert, and/or a short axial height requirement can be problematic with conventional valve seat inserts. There is, therefore, a need for an improved valve seat insert, particularly for split-cycle engines.

### SUMMARY OF THE INVENTION

The present invention offers advantages over the prior art by providing an improved valve seat insert. The improved valve seat insert is capable of staying in place within a recess of a cylinder head while providing a valve seat for a fast actuating, outwardly opening valve with a short axial height, which operates under high pressure conditions. The present invention further provides an innovative method and valve seat insert tool for installing an improved valve seat insert into the recess of a cylinder head.

The improved valve seat insert innovatively combines a cylindrical interference fit section and a threaded section. The interference fit section aligns the valve seat and can prevent rotation of the valve seat insert. The threaded section prevents axial movement of the valve seat insert.

The improved method for installing the valve seat insert heats the cylinder head or cools the valve seat insert, threads the valve seat insert into a recess of the cylinder head using a further innovative valve seat tool, and then allows the cylinder head and valve seat insert to come to approximately the same temperature and create an interference.

These and other advantages are accomplished in an exemplary embodiment of the invention by providing a valve seat insert including a valve seat insert body, a passage extending through the body that fluid can flow through, a valve seat disposed in the passage, and an outer periphery of the body including an interference section and a threaded section.

A further embodiment of the present invention may include an apparatus comprising a cylinder head disposed on a cylinder. The apparatus may further include a valve seat insert, disposed in a recess of the cylinder head, and including a valve seat insert body, a passage extending through the body that fluid can flow through, a valve seat disposed in the passage, and an outer periphery of the body disposed within the cylinder head and including an interference section and a threaded section. The apparatus may further include an outwardly opening valve having an open position wherein the valve is located off of the valve seat and away from an interior of the cylinder, and a closed position wherein the valve abuts the valve seat. The valve may control fluid communication into or out of the cylinder through the passage by reciprocating between the open and closed positions such that the valve repeatedly impacts the valve seat in an axial direction toward the interior of the cylinder. The interference section may align the valve seat such that the valve seat is concentric with a center line axis of the valve. The threaded section may prevent axial movement of the valve seat insert toward the interior of the cylinder during the repeated impacts.

A further embodiment of the present invention may include a method for installing a valve seat insert into a recess in a cylinder head. The valve seat insert may include a valve seat insert body, passage extending through the body that fluid can flow through, a valve seat disposed in the passage, and an outer periphery including an interference section and a threaded section. The recess in the cylinder head may include an interference section for receiving the interference section of the valve seat insert and a threaded section for receiving the threaded section of the valve seat insert. The method may include heating the interference section of the recess or cooling the interference section of the valve seat insert. The method may further include threading the threaded section of the valve seat insert into the threaded section of the recess, wherein the interference section of the recess receives the interference section of the valve seat insert. After assembly, the method may further include cooling the interference section of the recess or heating the interference section of the valve seat insert, such that the interference section of the recess and the interference section of the valve seat insert comes to approximately the same temperature and create an interference.

These and other features and advantages of the invention will be more fully understood from the following detailed description of the invention taken together with the accompanying drawings.

### BRIEF DESCRIPTION OF THE DRAWINGS

FIG. 1 is a cross-sectional view of a prior art split-cycle engine related to the engine of the invention;

FIG. 2 is a cross-sectional view of an exemplary split-cycle engine with valve seat inserts according to the present invention;

FIG. 3 is a bottom view of a valve seat insert according to the present invention.

FIG. 4 is a side view of a valve seat insert according to the present invention.

FIG. 5 is illustrates a valve seat insert according to the present invention.

FIG. 6 shows a magnified version of the crossover expansion valve (XovrE) of FIG. 2.

FIG. 7 illustrates a seating tool according to the present invention.

FIG. 8 is a top view of a seating tool attached to a valve seat insert according to the present invention.

FIG. 9 is a side view of a seating tool attached to a valve seat insert according to the present invention.

FIG. 10 shows a magnified version of the crossover expansion valve (XovrE) of FIG. 2 in an alternative valve seat insert embodiment according to the present invention.

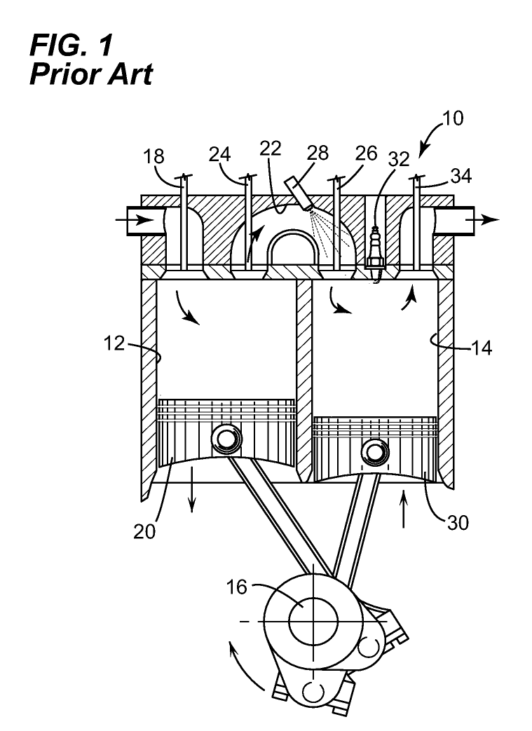

### DETAILED DESCRIPTION OF THE INVENTION

### Split-Cycle Engine

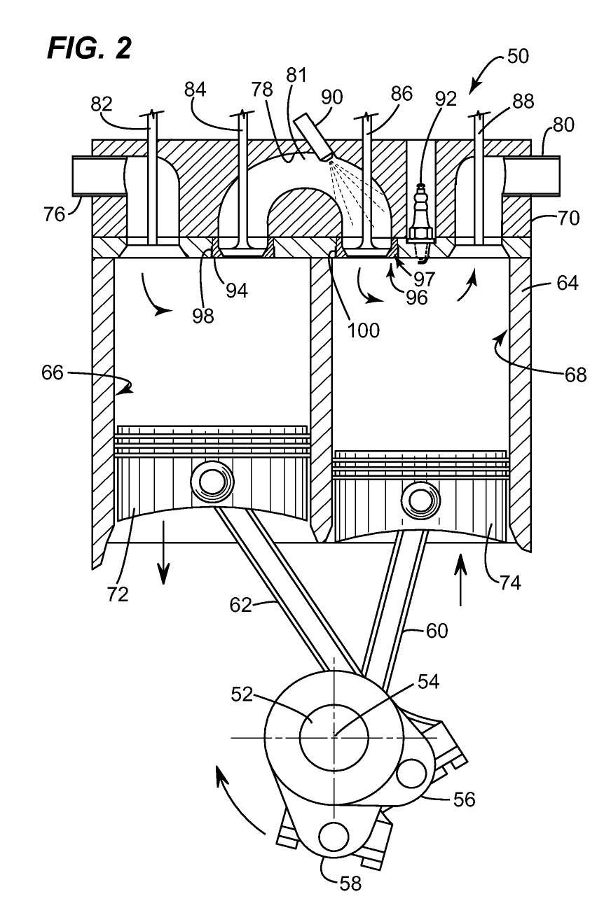

Referring now to FIG. 2 in detail, numeral 50 generally indicates a diagrammatic representation of a split-cycle engine according to the invention. Engine 50 includes a crankshaft 52 rotatable about a crankshaft axis 54 in a clockwise direction as shown in the drawing. The crankshaft 52 includes adjacent angularly displaced leading and following crank throws 56, 58, connected to connecting rods 60, 62, respectively.

Engine 50 further includes a cylinder block 64 defining a pair of adjacent cylinders, in particular a compression cylinder 66 and an expansion cylinder 68 closed by a cylinder head 70 at one end of the cylinders opposite the crankshaft 54.

A compression piston 72 is received in compression cylinder 66 and is connected to the connecting rod 62 for reciprocation of the piston between top dead center (TDC) and bottom dead center (BDC) positions. An expansion piston 74 is received in expansion cylinder 68 and is connected to the connecting rod 60 for similar TDC/BDC reciprocation. The diameters of the cylinders and pistons and the strokes of the pistons and their displacements need not be the same.

In an exemplary embodiment, the cylinder head 70 provides the means for gas flow into, out of and between the cylinders 66, 68. In the order of gas flow, the cylinder head includes an intake port 76 through which intake air is drawn into the compression cylinder 66, a pair of crossover (Xovr) passages 78 (at least one passage required) through which compressed air (gas) is transferred from the compression cylinder 66 to the expansion cylinder 68, and an exhaust port 80 through which spent gases are discharged from the expansion cylinder. Crossover passage 78 also defines a pressure chamber 81 in which pressurized gas is stored between closing of the crossover expansion (XovrE) valve (86) during the expansion stroke of the expansion piston 74 on one cycle (crank rotation) of the engine and opening of the crossover compression (XovrC) valve (84) during the compression stroke of the compression piston 72 on the following cycle (crank rotation) of the engine.

In the selected embodiment, gas flow into the compression cylinder 66 is controlled by an inwardly opening intake valve 82, which may be actuated by any suitable engine drive mechanism, such as by an intake cam, not shown. Gas flow into and out of crossover passage 78 may be controlled by a pair of outwardly opening valves, namely a crossover compression (XovrC) valve 84 at an inlet end of each Xovr passage and a crossover expansion (XovrE) valve 86 at an outlet end of the crossover passage 78. XovrC valve 84 and XorvE valve 86 can be any suitable type of valves, but are preferably poppet valves.

XovrC valve 84 and XovrE valve 86 each reciprocate between open and closed positions. In their open positions, valves 84, 86 are located off of their corresponding valve seats and away from the interior of their corresponding cylinders 66, 68. For example, XovrC valve 84 opens by retreating away from cylinder 66 into crossover passage 78, thereby allowing fluid to flow between compression cylinder 66 and crossover passage 78. XorvC valve 84 closes by abutting a valve seat as shown in FIG. 2, thereby preventing fluid from flowing between compression cylinder 66 and crossover passage 78.

XovrC valve 84 and XovrE valve 86, in their closed positions, each abut valve seat inserts 94, 96 in accordance with the present invention. Each valve seat insert 94, 96 includes a generally cylindrical valve seat insert body 97 with a passage 102 extending therethrough. The gas flow into and out of crossover passage 78 is through passages 102 in valve seat inserts 94, 96, which are subsequently discussed in detail.

Valve seat inserts 94, 96 are each installed in respective recesses 98, 100 in cylinder head 70. Recesses 98, 100 are subsequently discussed in further detail.

Exhaust gas flow out the exhaust port 80 is controlled by an inwardly opening exhaust valve 88 actuated, such as by an exhaust cam, not shown. The cams may be mechanically engine driven or operated by any other suitable engine drive mechanism, with timing as desired relative to the instantaneous angular position of the crankshaft 52, or alternative torque output device.

Crossover passage 78 has at least one high pressure fuel injector 90 disposed therein. The fuel injectors are operative to inject fuel into charges of compressed air within the pressure chambers 81 of the crossover passages 78.

Engine 50 also includes one or more spark plugs 92 or other ignition devices. The spark plugs 92 are located at appropriate locations in the end of the expansion cylinder 68 wherein a mixed fuel and air charge may be ignited and burned during the expansion stroke. Alternatively, engine 50 may also be configured as a compression ignition engine, instead of a spark ignition engine, and still be within the scope of this invention.

The ratio of the volume in compression cylinder 66 when piston 72 is at its bottom dead center (BDC) position to the volume in compression cylinder 66 volume when piston 72 is at its top dead center (TDC) position is referred to herein as the Compression Ratio. This ratio is generally much higher than the ratio of cylinder volumes between BDC and TDC of a conventional engine. In order to maintain advantageous efficiency levels, the Compression Ratio is typically set at approximately 95 to 1. Moreover, the Compression Ratio is preferably equal to or greater than 20 to 1, more preferably equal to or greater than 40 to 1, and most preferably equal to or greater than 80 to 1.

The ratio of the volume in expansion cylinder 68 when piston 74 is at its BDC position to the volume in expansion cylinder 68 volume when piston 74 is at its TDC position is referred to herein as the Expansion Ratio. This ratio is generally much higher than the ratio of cylinder volumes between BDC and TDC of a conventional engine. In order to maintain advantageous efficiency levels, the Compression Ratio is typically set at approximately 50 to 1. Moreover, the Compression Ratio is preferably equal to or greater than 20 to 1, more preferably equal to or greater than 40 to 1, and most preferably equal to or greater than 50 to 1.

### Valve Seat Insert(s)

Valve seat insert 96 and recess 100 (both shown in FIG. 2) are described below in further detail. It should be understood that the following description also applies to valve seat insert 94 and recess 98 (also both shown in FIG. 2).

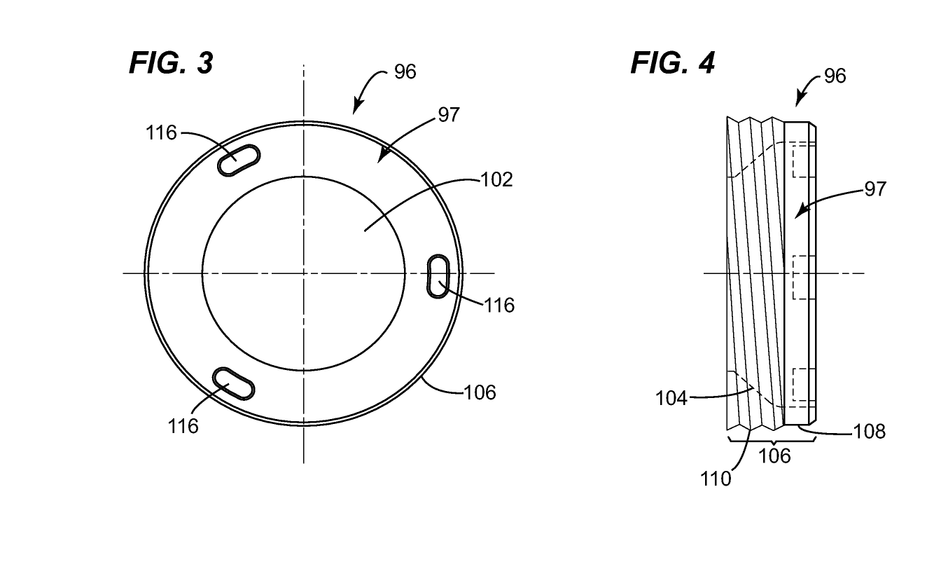

FIGS. 3-5 illustrate a valve seat insert 96 according to the present invention. Valve seat insert 96 has a generally cylindrical body 97, the body 97 includes an inner passage 102, a valve seat 104 within the passage 102, and an outer periphery 106.

Passage 102 is capable of having fluid, such as air, gas, or a combination thereof, flow therethrough (as described above in reference to FIG. 2.) Valve seat 104 of passage 102 is tapered to receive a tapered valve such as outwardly opening valve 86 (shown in FIG. 2). That is, valve 86 can abut valve seat 104 and thereby seal passage 102 so that fluid cannot flow therethrough.

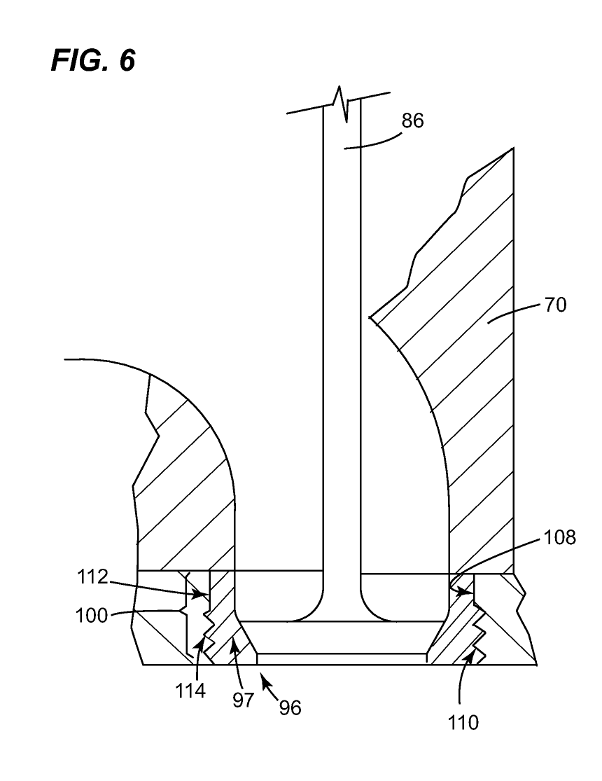

Outer periphery 106 includes a radial interference section 108 and a threaded section 110. Notably, the height of the interference section 108 along its centerline axis is substantially shorter than (i.e., preferably less than or equal to one half (½), and more preferably less than or equal to one quarter (¼)) the interference section 108's outer diameter. Therefore, the amount of compression will be limited, impairing its capability to prevent rotation. Accordingly, the diameter of interference section 108 is machined to be at least slightly larger than the diameter of corresponding interference section 112 (best shown in FIG. 6) of recess 100 of cylinder head 70. The interference fit section 108 serves multiple purposes such as (1) preventing rotation of the valve seat insert 96 and (2) determining the position of the axis of the conical sealing surface of the valve seat with respect to the cylinder head 70.

It is important to note that due to the small length to diameter ratio (i.e., one half (½) or less) the magnitude of the retention force generated by the interference is sufficient to prevent the unscrewing of the valve seat insert while maintaining the stresses within the limits of component strength. However, it would not be sufficient to prevent the extraction of the valve seat insert from the cylinder head if the threaded section wasn't present.

Threaded section 110 preferably includes 1 to 6 external (or male) threads to prevent axial movement. Threaded section 110 can more preferably include 3 or 4 threads. This is because most of the axial load is generally transmitted through the first 3 or 4 engaged threads. However, the number of threads can preferably be reduced even further to 1 or 2 threads when, for example, the threaded male component is substantially hollow—like in the case of the valve seat insert. The matching threaded section 114 (best shown in FIG. 6) of recess 100 includes substantially the same number of threads as threaded section 110, but the threads of recess 100 are internal (or female).

The small number of threads in threaded section 110 are capable of handling the high axial forces generated by the repeated impacts of valve 86 without the drawbacks of the high material stresses of a high interference fit in the interference section 108. Additionally, the short axial height of the combined threaded 110 and interference 108 sections required enables the packaging of other components in the crowded cylinder head assembly.

Accordingly, the role of the interference fit section 108 in the outer periphery 106 of valve seat insert body 97 is not to prevent axial sliding of the valve seat insert 96 out of its recess 100 of the cylinder head 70, but is to prevent the rotation and consequent unscrewing of the valve seat insert 96. Additionally, the interference fit section 108 provides a better surface than threaded section 110 to ensure that the positioning of the sealing surface of the valve seat 104 is properly positioned with respect to the cylinder head 70.

The bottom of valve seat insert body 97 includes a plurality of (e.g., 3) slots 116, as shown in FIG. 3. Slots 116 are indentations that are sized to receive pins of a seating tool, which is described in further detail below.

FIG. 6 illustrates valve seat insert 96 installed in recess 100 of cylinder head 70 in detail. Recess 100 includes an interference section 112 and a threaded section 114.

The innovative utilization of interference sections 108 and 112, and possibly threaded sections 110 and 114, to prevent rotation of the valve seat insert 96 and utilization of threaded sections 110 and 114 to prevent axial movement of the valve seat insert 96 advantageously keeps valve seat insert 96 in recess 100 of cylinder head 70. This innovative design keeps valve seat insert 96 in place under the repeated impacts of a split-cycle engine and allows the axial height of valve seat insert 96 to be short enough to use in split-cycle engines. Further, the interference fit between interference sections 108 and 112 advantageously aligns valve seat 104 to be concentric with the center line axis of valve 86.

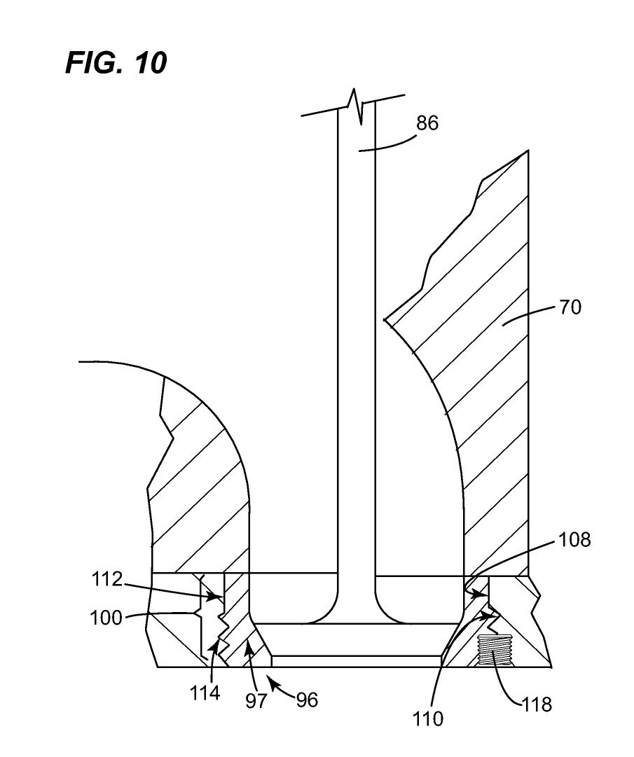

FIG. 10 shows a second embodiment of the present invention, wherein a pin 118 is used to prevent or to help prevent rotation of valve seat insert 96. In this embodiment the interference between interference section 108 of valve seat insert 96 and interference section 110 of recess 100 can, if desired, be reduced or eliminated.

In the second embodiment, a small threaded hole for receiving threaded pin 118 is used. A portion of the hole is disposed in the outer periphery 106 of valve seat insert 96 and a portion of the hole is disposed in cylinder head 70. These respective portions of the hole can be machined before valve seat insert 96 is installed into cylinder head 70, or the hole can be drilled after valve seat insert 96 is installed in cylinder head 70. In either case, after valve seat insert 96 is installed in the cylinder head 70, pin 118 is threaded into the hole. The pin 118 prevents or helps prevent rotation of valve seat insert 96 because the pin 118 is disposed in both valve seat insert 96 and cylinder head 70 as is evident in FIG. 10. This embodiment may have some potential drawbacks such as stress concentration, but may have the advantage of making the valve seat insert 96 easier to remove.

In further embodiments, an interference fit can additionally be utilized between male threaded section 110 of valve seat insert 96 and female threaded section 114 of recess 100. That is, the diameter of male threaded section 110 can be machined to be at least slightly larger than the diameter of female threaded section 114.

### Valve Seat Insert Tool

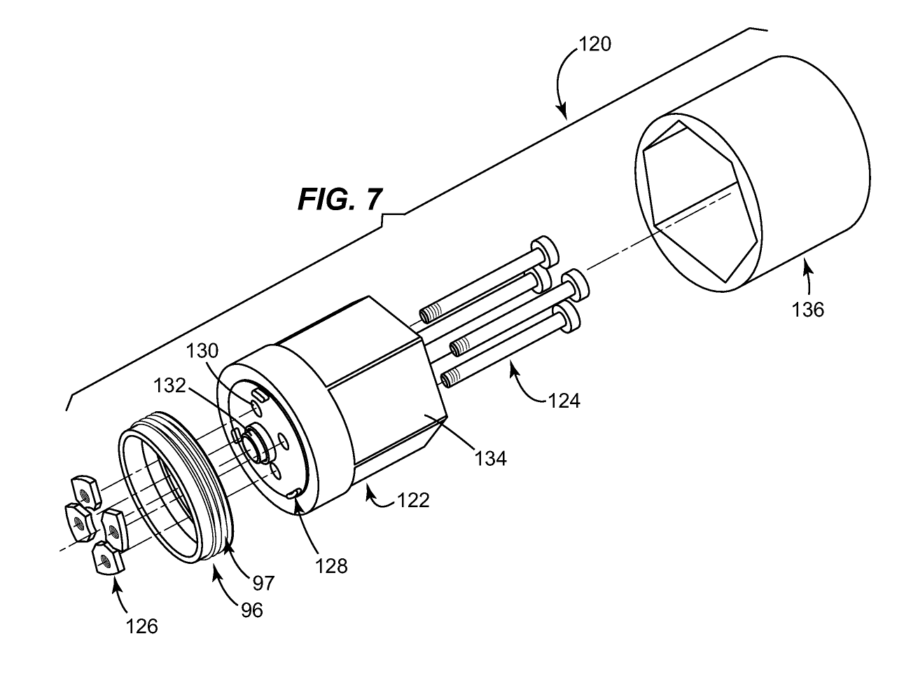

FIGS. 7-9 illustrate a valve seat insert tool 120 for installing a valve seat insert according to the present invention. Valve seat insert tool 120 includes tool head 122, a plurality of bolts 124, and a plurality of clamps 126. Tool head 122 includes a plurality of pins 128, a plurality of holes 130, nose 132, and hexagonal head 134. Socket 136 is for tightening valve seat insert 96 into recess 100.

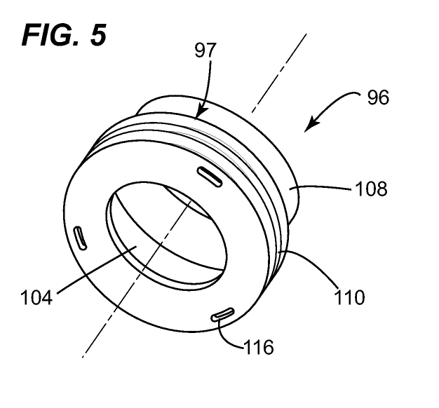

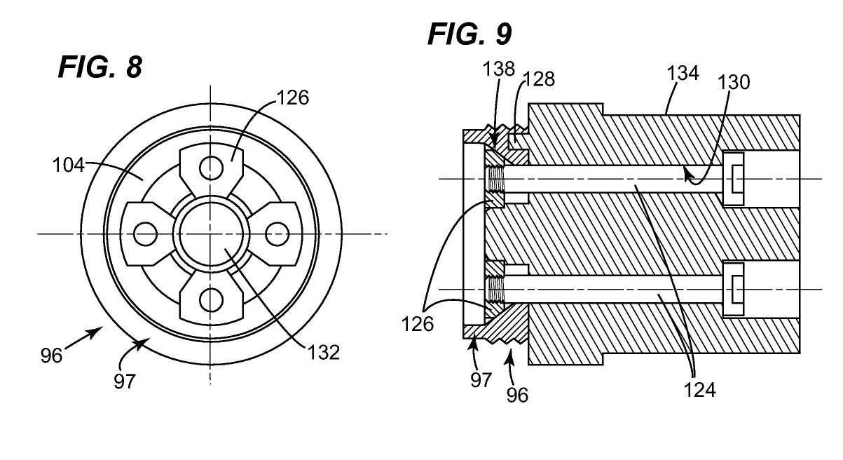

Valve seat insert tool 120 attaches to valve seat insert 96 in the following manner. Valve seat insert 96 is disposed on tool head 122 such that slots 116 (shown in FIG. 5) of valve seat insert 96 receive pins 128 (shown in FIG. 7) of tool head 122. Clamps 126 are arranged around nose 132 (as shown in FIG. 8). Bolts 124 are then inserted into holes 130 and screwed into clamps 126 (as shown in FIG. 9).

Clamps 126 include a tapered section 138, which match the taper of valve seat 104. When secured with bolts 124 the tapered section 138 of clamps 126 abut the taper of valve seat 104, thereby rigidly holding valve seat insert tool 120 and valve seat insert 96 together (as shown in FIG. 9). Pins 128 prevent valve seat insert 96 from rotating with respect to tool head 122, thereby transmitting the torque from the socket 136 directly to the valve seat insert 96.

### Method for Installing Valve Seat Insert

This section describes a method for installing valve seat insert 96 into recess 100 of cylinder head 70 (shown in FIG. 2) using valve seat insert tool 120.

First, outwardly opening valve 86 is passed through cylinder head 70 and installed in the valve train, not shown. This is because the head of valve 86 is too large to pass through passage 102 of valve seat insert 96.

Second, valve seat insert 96 is attached to valve seat insert tool 120, as previously described.

Third, one or both of the following steps can be taken to temporarily reduce the interference of the valve seat insert 96 with the cylinder head 70. Step one, heat is applied, at least locally, to interference section 112 of recess 100 of cylinder head 70, thereby causing it to expand radially. Step two, at least interference section 108 of valve seat insert 96 is cooled so that it contracts radially.

The aforementioned heating step may be performed by any suitable method. The aforementioned cooling step may comprise bringing valve seat insert 96 into contact with liquid nitrogen, or any other suitable method. If an interference fit is to be additionally utilized between threaded sections 110 and 114 then the aforementioned heating and/or cooling would be applied to the corresponding threaded sections as well.

Expansion of interference section 112 of cylinder head 70 and/or compression of interference section 108 of valve seat insert 96 make it easier to fit valve seat insert 96 into recess 100 of the cylinder head 70. However, under the proper conditions (e.g., use of component materials with sufficiently high coefficients of thermal expansion) installation of the valve seat insert 96 into recess 100 may be accomplished without radial expansion or contraction of the recess 100 and insert 96 respectively. Additionally, it may be possible to install the valve seat insert 96 into the recess 100 without the heating and cooling discussed above when, for example, a sufficiently small radial interfere is used.

Fourth, socket 136 is then used to thread exterior threads 110 of valve seat insert 96 into corresponding interior threads 114 of recess 100. The threading may require a large amount of torque, depending on the amount of radial interference between interference sections 108 and 112.

The assembly process takes a certain amount of time during which the hot cylinder head 70 comes into contact with the substantially colder valve seat insert 96. Because of the relatively small mass of the valve seat insert 96 compared to the cylinder head 70, the valve seat insert 96 would heat rapidly if it were not attached to a larger mass at approximately the same temperature. Therefore, the valve seat insert tool 120 can also be cooled and its substantial mass and thermal capacity (e.g., at least 4 times greater) relative to the valve seat insert 96 can be utilized to act as a heat sync to reduce the rate of expansion of the valve seat insert 96.

Fifth, valve seat insert tool 120 is removed (or detached) from valve seat insert 96. Bolts 124 are unscrewed and tool head 122 is removed. This allows clamps 126 to fall through passage 102. Importantly, clamps 126 are each individually small enough to pass through the portion of passage 102 with the smallest inner perimeter, known as the throat.

Sixth, interference section 112 of recess 100 is cooled so that it contracts raidally, interference section 108 of valve seat insert 96 is heated so that it expands radially, or both, such that interference sections 108 and 112 become approximately the same temperature. This, of course, creates the aforementioned radial interference fit between interference sections 108 and 112. If an interference fit is to be additionally utilized between threaded sections 110 and 114 then this heating and/or cooling would be applied to the corresponding threaded sections as well.

While various embodiments are shown and described herein, various modifications and substitutions may be made thereto without departing from the spirit and scope of the invention. Accordingly, it is to be understood that the present invention has been described by way of illustration and not limitation.

What is claimed is:

1. A valve seat insert, comprising:
a valve seat insert body;
a passage extending through the body that fluid can flow through;
a valve seat disposed in the passage; and
an outer periphery of the body including an interference section and a threaded section.

2. The valve seat insert of claim 1, wherein the valve seat insert body is generally cylindrical.

3. The valve seat insert of claim 1, wherein the valve seat is tapered.

4. The valve seat insert of claim 1, wherein the threaded section comprises 2 to 5 threads.

5. The valve seat insert of claim 1, further comprising a plurality of slots to receive pins of a seating tool.

6. The valve seat insert of claim 1, wherein the axial height of the interference section is less than or equal to one half (½) of the outer diameter of the interference section.

7. The valve seat insert of claim 1, wherein the axial height of the interference section is less than or equal to one quarter (¼) of the outer diameter of the interference section.

8. The valve seat insert of claim 1, wherein:
the outer periphery includes a portion of a hole for receiving a pin; and
the portion of the hole is capable of receiving a portion of the pin, but not the entire pin.

9. The valve seat insert of claim 8, wherein the threaded section of the outer periphery includes the portion of the hole.

10. The valve seat insert of claim 8, wherein the portion of the hole and the pin are threaded.

11. An apparatus, comprising:
a cylinder head disposed on a cylinder;
a valve seat insert disposed in a recess of the cylinder head, and including:
a valve seat insert body;
a passage extending through the body that fluid can flow through;
a valve seat disposed in the passage; and
an outer periphery of the body disposed within the cylinder head and including an interference section and a threaded section;
an outwardly opening valve including:
an open position wherein the valve is located off of the valve seat and away from an interior of the cylinder; and
a closed position wherein the valve abuts the valve seat;
wherein the valve controls fluid communication into or out of the cylinder through the passage by reciprocating between the open and closed positions such that the valve repeatedly impacts the valve seat in an axial direction toward the interior of the cylinder;
wherein the interference section aligns the valve seat such that the valve seat is concentric with a center line axis of the valve; and
wherein the threaded section prevents axial movement of the valve seat insert toward the interior of the cylinder during the repeated impacts.

12. The apparatus of claim 11, wherein the apparatus is a split-cycle engine, the cylinder is a compression cylinder of the split-cycle engine, the outwardly opening valve is an outwardly opening crossover compression (XovrC) valve of the split-cycle engine, and the apparatus further comprises:
a crankshaft rotatable about a crankshaft axis;
a compression piston slidably received within the compression cylinder and operatively connected to the crankshaft such that the compression piston reciprocates through an intake stroke and a compression stroke during a single rotation of the crankshaft;
an expansion (power) piston slidably received within an expansion cylinder and operatively connected to the crankshaft such that the expansion piston reciprocates through an expansion stroke and an exhaust stroke during a single rotation of the crankshaft;
a crossover passage interconnecting the compression and expansion cylinders, the crossover passage including the outwardly opening crossover compression (XovrC) valve and a crossover expansion (XovrE) valve defining a pressure chamber therebetween; and
wherein the outwardly opening crossover compression (XovrC) valve controls fluid communication through the passage of the valve seat insert between the compression cylinder and the crossover passage.

13. The apparatus of claim 11, wherein the apparatus is a split-cycle engine, the cylinder is an expansion (power) cylinder of the split-cycle engine, the outwardly opening valve is an outwardly opening crossover expansion (XovrE) valve of the split-cycle engine, and the apparatus further comprises:
a crankshaft rotatable about a crankshaft axis;
a compression piston slidably received within a compression cylinder and operatively connected to the crankshaft such that the compression piston reciprocates through an intake stroke and a compression stroke during a single rotation of the crankshaft;
an expansion (power) piston slidably received within the expansion cylinder and operatively connected to the crankshaft such that the expansion piston reciprocates through an expansion stroke and an exhaust stroke during a single rotation of the crankshaft;
a crossover passage interconnecting the compression and expansion cylinders, the crossover passage including a crossover compression (XovrC) valve and the outwardly opening crossover expansion (XovrE) valve defining a pressure chamber therebetween; and
wherein the outwardly opening crossover expansion (XovrE) valve controls fluid communication through the passage of the valve seat insert between the crossover passage and the expansion cylinder.

14. The apparatus of claim 11, wherein the valve seat insert body is generally cylindrical.

15. The apparatus of claim 11, wherein the valve seat is tapered such that the closed position of the valve seals the passage.

16. The apparatus of claim 11, wherein the threaded section comprises 2 to 5 threads.

17. The apparatus of claim 11, wherein the valve controls fluid communication through the passage between the cylinder and a pressure chamber.

18. The apparatus of claim 11, further comprising a piston slidably received within the cylinder and operatively connected to a crankshaft such that the piston reciprocates within the cylinder; and
wherein the ratio of cylinder volumes from bottom dead center (BDC) to top dead center (TDC) of the cylinder is 40 to 1 or greater.

19. The apparatus of claim 11, wherein the valve seat insert further comprises a plurality of slots sized to receive pins of a seating tool.

20. The apparatus of claim 11, wherein the axial height of the interference section is less than or equal to one half (½) of the outer diameter of the interference section.

21. The apparatus of claim 11, wherein the axial height of the interference section is less than or equal to one quarter (¼) of the outer diameter of the interference section.

22. The apparatus of claim 11, wherein the interference section prevents rotation of the valve seat insert.

23. The apparatus of claim 11, wherein there is an interference fit between the recess of the cylinder head and the interference section of the valve seat insert.

24. The apparatus of claim 11, further comprising:
a hole for receiving a pin;
wherein a portion of the hole is disposed in the cylinder head and a portion of the hole is disposed in the outer periphery of the valve seat insert body.

25. The apparatus of claim 24, wherein the portion of the hole disposed in the outer periphery of the valve seat insert body is disposed in the threaded section of the outer periphery.

26. The apparatus of claim 24, wherein the hole and the pin are threaded.

27. The apparatus of claim 24, the pin is disposed in the hole such that the pin prevents rotation of the valve seat insert.

28. A method for installing a valve seat insert into a recess in a cylinder head; the valve seat insert including a valve seat insert body, a passage extending through the body that fluid can flow through, a valve seat disposed in the passage, and an outer periphery of the body including an interference section and a threaded section; the recess in the cylinder head including an interference section for receiving the interference section of the valve seat insert and a threaded section for receiving the threaded section of the valve seat insert, comprising:
heating the interference section of the recess or cooling the interference section of the valve seat insert;
threading the threaded section of the valve seat insert into the threaded section of the recess, wherein the interference section of the recess receives the interference section of the valve seat insert; and
cooling the interference section of the recess or heating the interference section of the valve seat insert, such that the interference section of the recess and the interference section of the valve seat insert come to approximately the same temperature and create an interference.

29. The method of claim 28, further comprising:
heating the interference section of the recess and cooling the interference section of the valve seat insert.

30. The method of claim 28, further comprising:
cooling the interference section of the recess and heating the interference section of the valve seat insert, such that the interference section of the recess and the interference section of the valve seat insert become approximately the same temperature and create an interference.

31. The method of claim 28, further comprising:
passing a valve through the cylinder head before the threading.

32. The method of claim 28, further comprising:
using the interference section of the valve seat insert to prevent rotation of the valve seat insert.

33. The method of claim 28, further comprising:
using the interference section of the valve seat insert to align the valve seat insert with a center line axis of a valve.

34. The method of claim 28, further comprising:
using the threaded section of the valve seat insert to prevent axial movement of the valve seat insert.

35. The method of claim 28, wherein the valve seat insert body is generally cylindrical.

36. The method of claim 28, wherein the valve seat is tapered.

37. The method of claim 28, wherein the threaded section of the valve seat insert comprises 2 to 5 threads.

38. The method of claim 28, wherein the threading further comprises:
rotating a valve seat insert tool that has pins protruding into a plurality of slots of the valve seat insert.

39. The method of claim 38, wherein during said rotating the valve seat insert tool is attached to the valve seat insert by:
one or more clamps that are tapered to match a taper of the valve seat and are in contact with the taper of the valve seat; and
wherein the one or more clamps are operatively connected to a socket of the valve seat tool.

40. The method of claim 39, wherein the one or more clamps are operatively connected to the socket of the valve seat tool via one or more bolts.

41. The method of claim 40, further comprising:
disconnecting the one or more clamps from the socket of the valve seat tool; and
removing the clamps through a throat of the valve seat insert, wherein the throat is a portion of the passage with the smallest inner perimeter.

42. The method of claim 28, wherein the axial height of the interference section is less than or equal to one half (½) of the outer diameter of the interference section.

43. The method of claim 28, wherein the axial height of the interference section is less than or equal to one quarter (¼) of the outer diameter of the interference section.

44. The method of claim 28, wherein a hole for receiving a pin is disposed in both the cylinder head and the outer periphery of the valve seat insert body.

45. The method of claim 44, wherein the portion of the hole disposed in the outer periphery of the valve seat insert body is disposed in the threaded section of the outer periphery.

46. The method of claim 44, wherein the hole and the pin are threaded.

47. The method of claim 44, wherein the pin is disposed in the hole such that the pin prevents rotation of the valve seat insert.

48. The method of claim 28, further comprising drilling a hole into both the cylinder head and the outer periphery of the valve seat insert body such that the hole is capable of receiving a pin.

49. The method of claim 48, further comprising inserting a pin into the hole.

50. The method of claim 49, wherein the hole and the pin are threaded and inserting the pin into the hole includes threading the pin into the hole.
